(19) United States
(12) Patent Application Publication
(10) Pub. No.: US 2006/0078763 A1
(43) Pub. Date: Apr. 13, 2006

(54) Electrochemical generator

(76) Inventors: Antonino Toro, Segrate (IT); Daniele Facchi, Rovato (IT); Luca Merlo, Montorfano (IT)

Correspondence Address: HEDMAN & COSTIGAN P.C., 1185 AVENUE OF THE AMERICAS, NEW YORK, NY, 10036, US

(21) Appl. No.: 10/534,918

(22) PCT Filed: Nov. 10, 2003
(86) PCT No.: PCT/EP03/12527

§ 371 Date: May 10, 2005

(30) Foreign Application Priority Data
Nov. 11, 2002 (IT) MI2002A002383

(51) Int. Cl. H01M 8/00

(52) U.S. Cl. 429/12

(57) ABSTRACT

The present invention discloses an electrochemical generator fed with reactant gases, and in particular a fuel cell fed with a hydrogen-containing gas and with air at near ambient pressure. The electrochemical generator is characterised by asymmetry of the pressure drops localised in the distributing and collecting channels, wherein, in particular, the pressure drop concentrated in the collecting channels is substantially higher than that concentrated in the distributing channels. Moreover, the pressure in the active areas of the generator substantially coincides with the feeding one. Such a result is obtained by differentiating the design of the distributing channels from the one of the collecting channels, whose passage section is lowered and/or whose length is increased and/or whose amount is decreased.

### DESCRIPTION OF THE INVENTION

The present invention is relative to the field of membrane electrochemical generators, more particularly of generators consisting of polymer membrane fuel cells which carry out processes of chemical to electrical energy conversion. In particular, the invention is relative to a cell design enhancing the polymer membrane fuel cell efficiency, primarily useful for low working pressure operation.

For a better comprehension, the invention will be described making reference to some figures, exemplifying some embodiments thereof, without constituting a limitation of its scope.

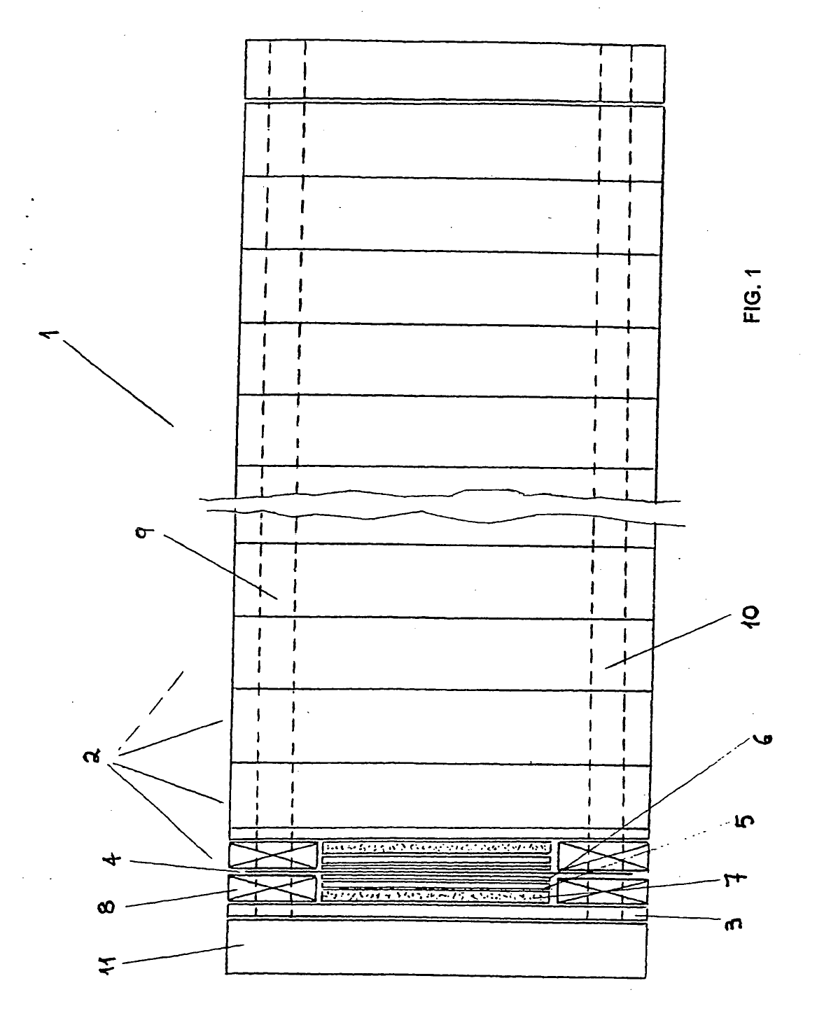

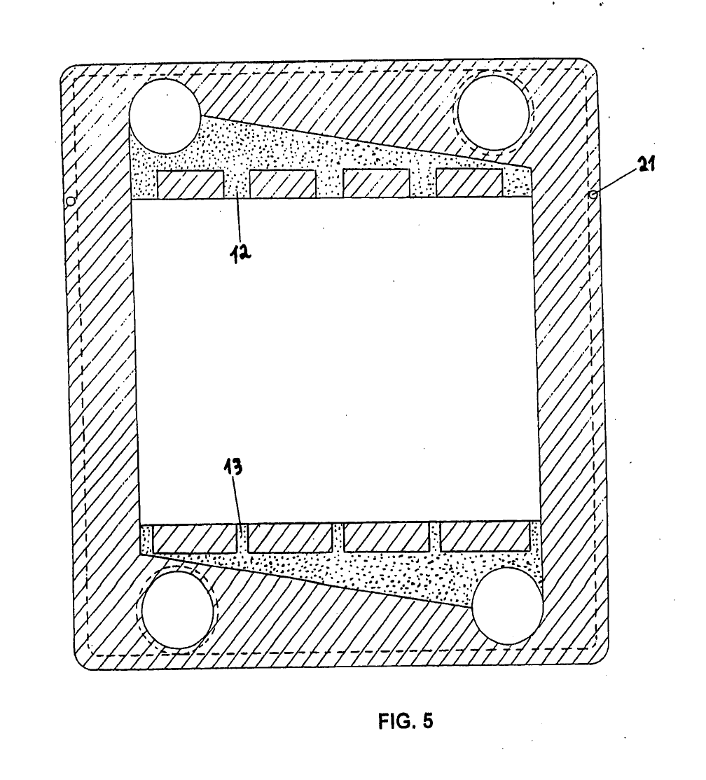

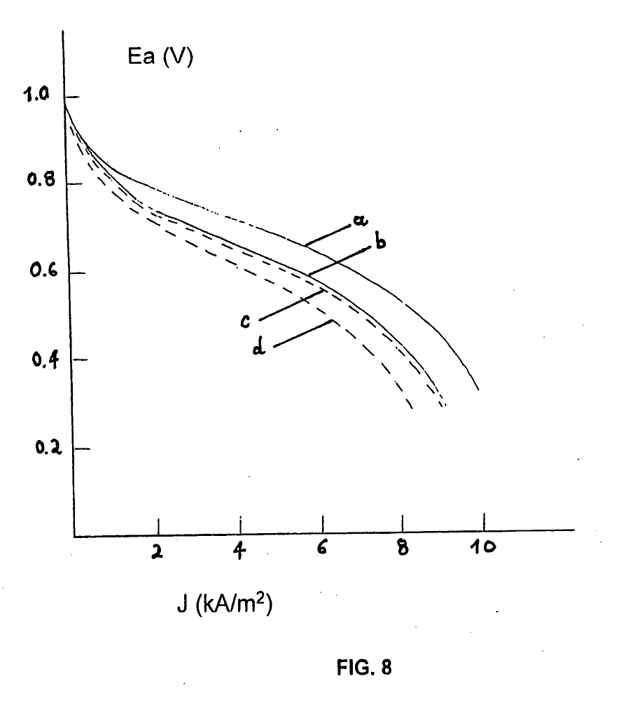

In particular, FIGS. 1 to 4 refer to electrochemical generators of the prior art; FIGS. 5 to 7 refer to some preferred embodiments of the invention; FIG. 8 reports a comparison of operative data relative to cells of the invention and of the prior art.

FIG. 1 shows an electrochemical generator comprising polymer membrane fuel cells.

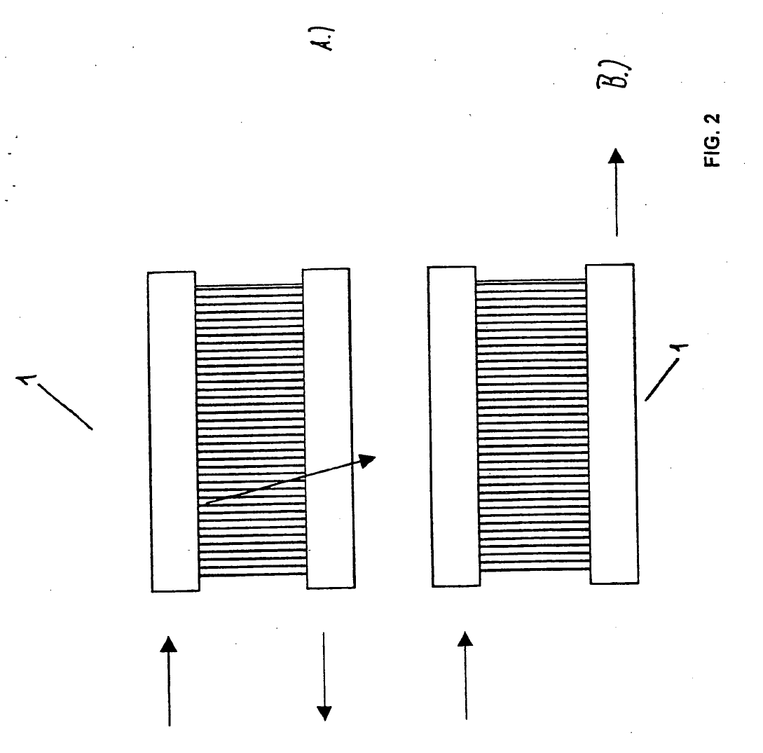

FIGS. 2A and 2B show two possible ways of distributing the reactant gases to the fuel cells of an electrochemical generator.

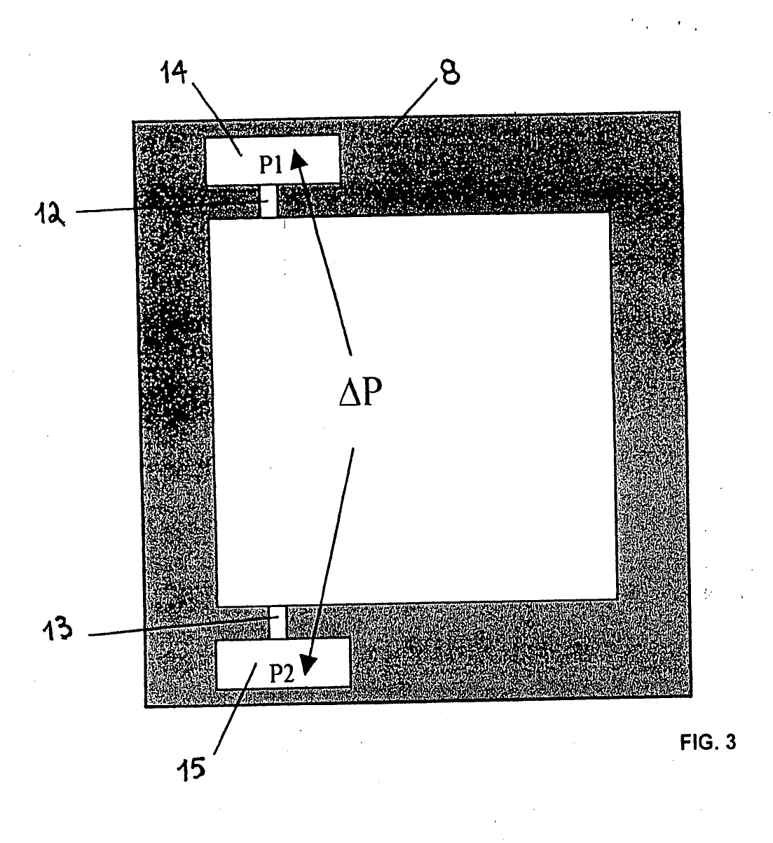

FIG. 3 outlines the distribution of pressures in a fuel cell.

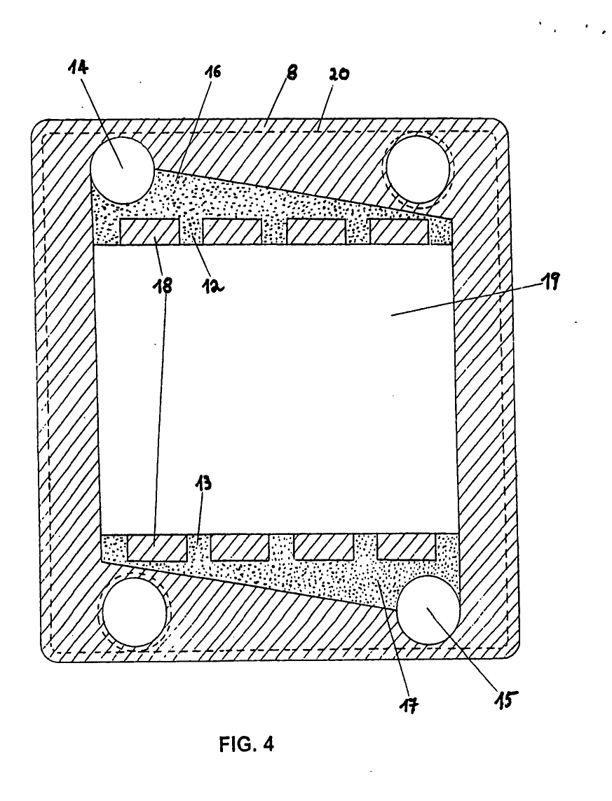

FIG. 4 shows the design of a gasket according to the teaching of the prior art.

FIGS. 5, 6 and 7 show designs of gaskets according to some preferred embodiments of the present invention.

FIG. 8 shows polarisation curves averaged for the various cells of an electrochemical generator according to the invention and to the prior art.

An example of electrochemical generator is sketched in FIG. 1. The electrochemical generator (1) is formed by a multiplicity of elementary cells (2), of rather reduced thickness to minimise the bulk, which are mutually connected in series, in parallel or in series-parallel and are assembled according to a filter-press type configuration. The first of these cells is represented in a cross-section showing the internal components.

Each elementary cell (2) converts the free energy of reaction of a first gaseous reactant (fuel) with a second gaseous reactant (oxidant) without degrading it completely to the state of thermal energy, and therefore without being subject to the limitations of Carnot's cycle. The fuel is supplied to the anodic compartment of each elementary cell (2) and consists for instance of a hydrogen-containing mixture, while the oxidant is supplied to the cathodic compartment of the same cells and consist for instance of air or oxygen. The fuel is oxidised in the anodic compartment simultaneously releasing H⁺ ions, while the oxidant is reduced in the cathodic compartment, consuming H⁺ ions with production of water. A proton conducting membrane separating the anodic and cathodic compartments allows the continuous flow of H⁺ ions from the anodic compartment to the cathodic compartment simultaneously preventing the passage of electrons. In this way, the difference of electric potential established at the poles of the elementary cell (2) is maximised.

In the case shown in figure, relative to a generator with cells in bipolar connection, each elementary cell (2) is delimited by a pair of conductive bipolar plates (3) enclosing the proton exchange membrane (4), a pair of porous electrodes (5), a pair of catalytic layers (6) deposited at the interface between the membrane (4) and each of the porous electrodes (5), delimiting the active area, a pair of porous current collectors/distributors (7) electrically connecting the conductive bipolar plates (3) to the porous electrodes (5) while simultaneously distributing the gaseous reactants and finally a pair of sealing gaskets (8) directed to seal the periphery of the elementary cell (2). As an alternative, the same function of the current collectors/distributors (7) may be accomplished by suitable grooves, e.g. in form of groove arrays (known as “flow-fields”), frequently disposed in serpentine patterns, obtained on the bipolar plates (3) by machining.

In the upper and lower regions of the conductive bipolar plates (3) and/or in the sealing gaskets (8) of each elementary cell (2) there are holes, not shown in FIG. 1, which are connected to the anodic compartment and the cathodic compartment of the cell itself respectively by means of distributing and collecting channels, also not shown in FIG. 1.

The coupling of these holes which occurs upon assembling the whole electrochemical generator, leads to the formation of two upper longitudinal manifolds (9) and two lower longitudinal manifolds (10). The two upper longitudinal manifolds (9), only one of which is shown in FIG. 1, are used for feeding the gaseous reactants (fuel and oxidant) while the two lower longitudinal manifolds (10), only one of which is shown in FIG. 1, allow the discharge of the reaction products (water) mixed with the optional exhausts (gaseous inerts and unconverted fraction of reactants).

The feed and discharge manifolds terminate in correspondence of terminal plates (11), where hydraulic connections for putting the electrochemical generator in communication with the rest of the system are also present (not shown in FIG. 1). Depending whether the inlets and outlets are all on the same terminal plate or on opposite plates, the reactant gas distributions are of the type with or without inversion of the flow direction (respectively known in the art as “reversed” or “parallel”) as shown in the electrochemical generator sketch of FIGS. 2A and 2B respectively.

Alternatively, the lower longitudinal manifolds (10) may be used as feed manifolds and the upper longitudinal manifolds (9) as discharge manifolds. It is also possible to feed one of the two gaseous reactants through one of the upper longitudinal manifolds (9), making use of the respective lower longitudinal manifold (10) for the discharge, and to feed the other reactant gas through the other lower longitudinal manifold (10) making use of the respective upper longitudinal manifold (9) for the discharge.

The gaseous reactants are then distributed to each elementary cell (2) through distributing channels, while the reaction products and optional exhausts coming from each elementary cell (2) are extracted through collecting channels.

As mentioned above, at the two extremities of the assembly of elementary cells (2), two terminal plates (11) delimiting the electrochemical generator (1) are present: in the case of reversed gas distribution the nozzles, required for the connection of the upper (9) and lower longitudinal manifolds (10) to the ducts for supplying the reactant gases and extracting the exhaust gases and the reaction products, are all localised on one of the two plates (11) only. Furthermore, both of the plates (11) are provided with suitable holes (also not shown in figure) for housing tie-rods by means of which the clamping of the electrochemical generator (1) is accomplished.

The electrochemical generator (1) must have all of its constituting elementary cells supplied with the reactant gases in a constant and equal fashion, and the fluid-dynamic distribution must be therefore studied so that the flow-rate of the reactant gases be subdivided in a substantially uniform manner between each cell.

It is known in the art that, in order to obtain a uniform flow through each elementary cell, it must be ensured that the pressure drop, that is, as shown in FIG. 3, the difference or fall of pressure ΔP between the inlet point of the distributing channels (12) (pressure equivalent to P₁) and the outlet point of the collecting channels (13) (pressure equivalent to P₂) be higher than a certain critical value and that, particularly in the case of reversed fluid distribution, such value be also largely higher than the pressure drop within the ducts. FIG. 3 represents a front-view of a sealing gasket (8) in whose thickness the distributing channels (12) and collecting channels (13) are obtained: these channels put the active area of each cell in communication with the holes (14) and (15) whose coupling in the electrochemical generator leads to the formation of the upper (9) and lower (10) longitudinal manifolds, respectively.

The term ΔP results to be constituted by the sum of several factors, that is pressure drops or losses either localised (inlets, outlets, bends, widening and narrowing of passage sections) or distributed (along the different channels making up the gas path). These factors vary of course with the variations in the reaction cell geometry. Usually, for cells provided with flow-fields for gas distribution, the pressure drops are high and distributed along the grooves forming the flow-field serpentines. In this situation, the pressure drops localised within the distributing and collecting channels are usually minimised, by resorting to wide passage sections. Conversely, in the case of cells equipped with porous collectors/distributors, the pressure drops within the porous collectors/distributor are negligible. Since as disclosed above it is in any case necessary to have a minimum ΔP, the gas flow equalisation through the different elementary cells may only be obtained by increasing the pressure drops localised in the distributing and collecting channels. This goal is usually achieved in the prior art by decreasing the number and size of both the distributing and the collecting channels and/or increasing the length thereof, so that the required pressure drop is reached. This internal design, although effective in achieving a uniform gas flow-rate through the single elementary cells, does not always result satisfactory, since the pressure drop localised in the distributing channels placed in the inlet region of the elementary cells, which can be esteemed as at least a few tens of millibars, and preferably of one to two hundred millibars, determines a pressure reduction within the active region of each elementary cell with respect to the delivery pressure of the gases, which is substantially equivalent to the pressure inside the feed manifolds. This issue is of secondary importance when the electrochemical generator operates at pressures substantially higher than ambient, but becomes relevant when the operating pressure is maintained close to ambient, typically in the range between 1.02 and 1.50 atm. The reason for such behaviour is immediately clear considering that the performances of the electrochemical generators fed with gaseous reactants depend precisely from the pressure and that, for a given pressure reduction, the lower is the operating pressure the more relevant is the effect. Low pressure operation is considered particularly interesting by the experts of the fields as it allows getting rid both of the gas compressors with the associated energy consumption, replacing them with more reasonable fans, and of the complex and expensive expanders which are required to recover, by expanding the exhaust gases discharged from the electrochemical generator, at least part of the compression work. It is commonly reckoned that the systems operating at near ambient pressure require a lower capital investment, employ mechanical parts of already widespread industrial use and for this reason turn out to be substantially reliable.

In view of this situation the present invention is directed to achieving a design of electrochemical generators made up of elementary cells equipped with porous current collectors/distributors overcoming the limitations of the prior art, permitting to obtain a uniform reactant gas distribution also in case of operation at near ambient pressure.

According to a first aspect, the present invention is relative to an electrochemical generator consisting of a multiplicity of elementary cells provided with porous collectors/distributors, wherein the pressure drops respectively localised in the distributing channels of the gaseous reactants and in the collecting channels of the reaction products and exhausts are asymmetrical.

In a second aspect of the present invention the asymmetrical pressure drops in the distributing and collecting channels are established so that the pressure drop in the collecting channels be substantially higher than the pressure drop in the distributing channels.

In a third aspect of the invention the pressure in correspondence of the active area of each elementary cell results substantially close to the pressure in the feed manifolds.

The optimum functioning of the generators operating at near ambient pressure is particularly critical since as known to those skilled in the art, it depends in a very prominent manner from the effective pressure level established in the active area of each elementary cell, which level must be as high as possible. On the other hand, as recalled above, the porous collectors/distributors (7) crossed by the reactant gas flows, are characterised by minimum pressure drops and in order to ensure a uniformity of feed of the reaction gases to all the elementary cells it is mandatory to increase the pressure drops externally to the elementary cell active area concentrating the same in the distributing and collecting channels. As for both types of channels the prior art describes symmetrical designs, the pressure drops localised within the distributing channels result necessarily equivalent to those localised within the collecting channels and have a non negligible value, in the order of at least a few tens of millibars. Since the effective pressure in the active area of the single elementary cells results to be given by the difference from feed pressure (practically coincident with the pressure in the feed manifolds) and pressure drop in the distributing channels, it follows that the symmetrical design adopted in the prior art is fully contradictory with the requirement of maintaining a high pressure in correspondence of the active areas of the single elementary cells. On the other hand, in this situation it is not possible to recover the optimum pressure level by increasing the external feed pressure: to increase the external pressure would in fact mean to make use of compressors instead of conventional fans, which are largely employed components in a multiplicity of applications, inexpensive in terms of investment and operation cost and fundamentally reliable. Compressors are conversely more complex machines, with remarkably higher operating costs and with a certainly lower reliability, in particular for the gas flow-rate range required by the electrochemical generators. The reason why in the prior art symmetrical designs are usually described for the distributing and collecting channels must be probably sought in the higher simplicity and assembling reliability of the elementary cells in an electrochemical generator. In fact, if the sealing gaskets (8) have a symmetrical design, a possible rotation along the horizontal axis thereof does not entail particular problems for the elementary cells involved in the subsequent operation: the collecting channels that would be placed in the upper position would not determine any alteration of the functioning, being practically indistinguishable from the distributing channels now placed below.

The present invention describes an electrochemical generator whose elementary cells are characterised by having an asymmetrical design of the distributing and collecting channels. More particularly, the asymmetrical design proposed by the invention allows transferring all or essentially all of the pressure drop required to ensure a uniform reactant gas feed to the collecting channels.

This result is obtained through at least one of the following measures being applied to the collecting channels: reduction of the passage section, increase of the length, reduction in number.

At the same time, substantially specular modifications with respect to the above listed measures may be applied to the distributing channels, in particular consisting of the widening of the passage section and/or the reduction of the length and/or the increase in number.

As a consequence of the adoption of the asymmetrical design it is possible to fix the pressure drop values to respectively a few millibars for the distributing channels and to tens of millibars, preferably one to two hundred millibars, for the collecting ones.

FIGS. 5, 6 and 7 outline the new design proposed by the invention for the distributing and collecting channels compared in FIG. 4 to that known in the prior art. The figures make reference to the case wherein the distributing and collecting channels are obtained in the thickness of the sealing gaskets (8). It is clear that equivalent designs are applicable to the case wherein the distributing and collecting channels are obtained in the thickness of the bipolar plates (3) or in the thickness of optional sealing gaskets pressed on the bipolar plates to constitute a single integrated component.

FIG. 4 presents a front-view of a sealing gasket (8) according to the indications of the prior art, in particular a front-view of the face destined to be put in contact with the relevant bipolar plate is represented, wherein (16) identifies the connecting section between distributing channels (12) and holes (14), (17) the connecting section between collecting channels (13) and holes (15). Such sections and the relevant channels are obtained in the thickness of the gaskets (8) thereby lying on a plane recessed for a certain depth with respect to the sealing surface. The channels result defined by portions (18) whose surface is coplanar to the sealing one: such coplanar surfaces are hatched for a better comprehension, while the plane of sections (16) and (17 of the distributing channels (12) and (13) is dotted. Sections (16) and (17) may be provided with ribs (not represented in FIG. 4) or with a filling consisting of fragments of low pressure drop porous material equivalent to the one used for the collectors/distributors with the purpose of guaranteeing non-deformability even under the pressure determined by the tightening of the elementary cells of the electrochemical generator. (19) identifies the active area filled by the porous electrodes-catalytic layers-membrane assembly not represented in FIG. 4. (20) finally represents a step protruding from the sealing surface, directed to prevent the external leakage of the reactant gases and the products.

As it can be noticed, the design of the distributing channels and collecting channels, corresponding to what proposed in the prior art, is symmetrical being the passage section and the amount of channels equivalent. This implies that during operation, the pressure drop experienced by each elementary cell is equally localised on the distributing channels (12) and the collecting channels (13). Since the overall pressure drop must be substantial so as to ensure a uniformity of distribution as previously said, it follows that even the pressure drop portion localised in the distributing channels (12) alone is significant: therefore the pressure in the active areas of the various elementary cells results sensibly lower than the feed pressure, with performance decay.

FIG. 5 represents a first embodiment of the present invention, characterised by having collecting channels (13) in an equivalent amount to the distributing channels (12) but with decreased passage section. Upon appropriately dimensioning the passage sections of the distributing channels (12) and of the collecting channels (13) it is possible to reduce the pressure drop within the distributing channels (12) to negligible values, simultaneously increasing the pressure drop in the collecting channels (13) to values which permit guaranteeing a uniform distribution of gas flow-rate to the various elementary cells. In this way the important scope of the present invention to maintain a pressure in the active area practically coincident to the feed one is achieved, as it is particularly advantageous in the case of operation at near ambient pressure.

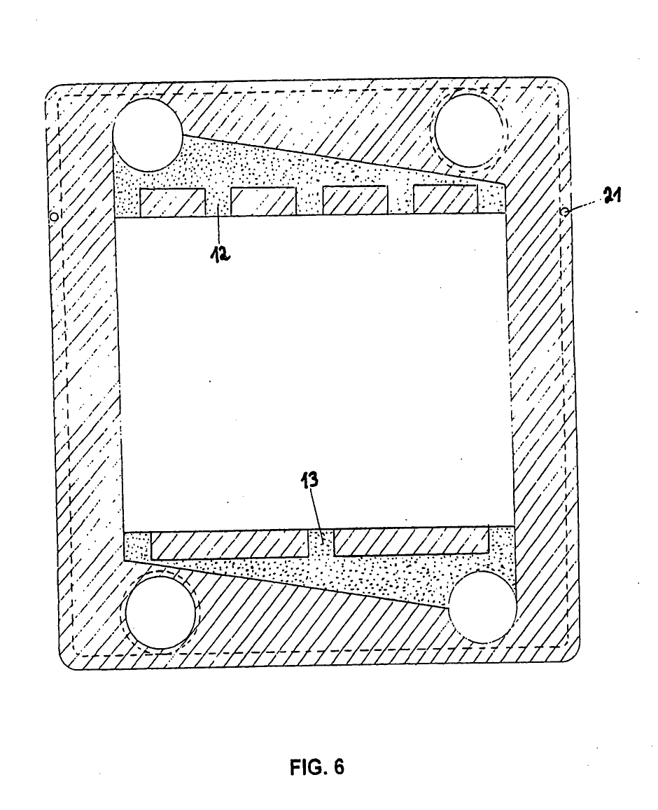

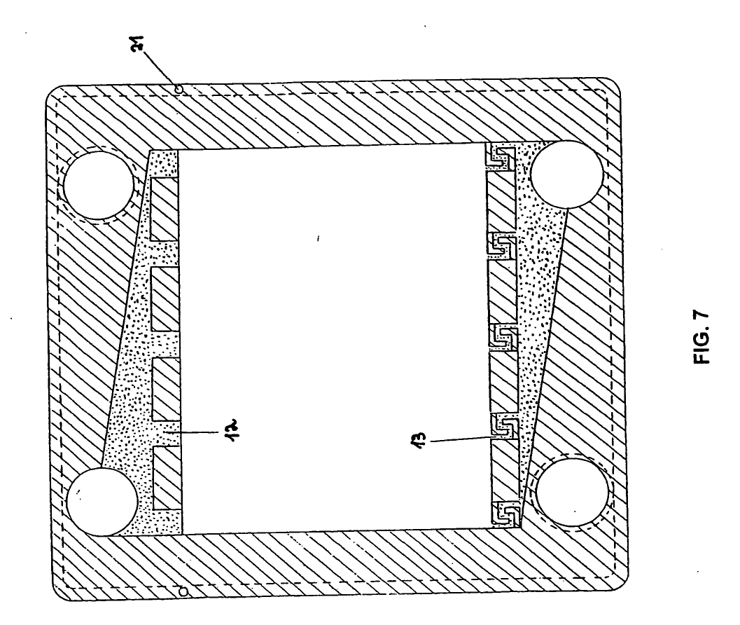

FIGS. 6 and 7 make reference to two further embodiments of the present invention, in particular based on the decrease in number (FIG. 6) and the increase in length (FIG. 7) of the collecting channels (13). In the latter case, the greater length is preferably achieved by adopting a serpentine design allowing not to increase the external size of the sealing gaskets and of the elementary cells, as it is important to maintain reduced bulks.

Also in this case, by appropriately dimensioning the passage section of the distributing channels (12) and the amount or length of the collecting channels (13) it is fully possible to minimise the pressure drop within the distributing channels (12) concentrating the overall pressure drop in the collecting channels (13). In such a way the two results of keeping on ensuring a uniform gas distribution between the various elementary cells and of maintaining an operative pressure in the active areas practically coincident to the feed one are simultaneously achieved. In particular, assuming as representative average values of the distributing and collecting channels of the prior art 10 mm² for the overall passage section, 5 mm for the length and 5 for their amount, it has been found that the desired results in terms of pressure drop as indicated above are obtainable with the following combinations exemplifying modifications applied to the collecting channels alone:

a—overall passage section: 4 mm²

length: 5 mm
amount: 2
   b—overall passage section: 6 mm²
length: 15 mm
amount: 3
   c—overall passage section: 4 mm²
length: 5 mm
amount: 5

The design modifications of the collecting channels indicated above as a mere example of application may be coupled to unchanged designs of the distributing channels or alternatively, wishing to minimise the pressure drop in the active areas, to distributing channel designs characterised by increase of the passage sections and/or reduction of their length and/or increase in their number.

The efficacy of the asymmetrical design of the distributing and collecting channels has been demonstrated with the operation of an electrochemical generator comprised of twenty elementary cells equipped with 5 distributing channels, having an overall passage section of 10 mm² and a length of 5 mm and collecting channels with design of type b as specified above.

The generator was fed in two distinct tests at 1.2 and 1.4 bar abs. with pure hydrogen at 10% excess with respect to the stoichiometric value and with air at twofold excess with respect to the stoichiometric value, maintaining the internal temperature around 70° C. The results are collected in FIG. 8 together with those characteristic of an equivalent electrochemical generator, except for the sealing gaskets provided with symmetrical distributing and collecting channels, in each case being in the amount of 5 and with an overall passage section of 10 mm² and length 5 mm. The obtained performances are indicated by the continuous curves a) and b) for the generator in accordance with the invention operating respectively at 1.4 and 1.2 atm, and by the dashed curves c) and d) for the generator in accordance with the prior art. As it can be noticed, the generator in accordance with the prior art can give equivalent performances to those of the generator in accordance with the present invention only if the feed pressure thereof is increased by about 0.2 atm. It has been further noticed that the single elementary cell voltages of the generator in accordance with the present invention were confined within a close range of only 30 millivolts attesting the efficacy of the collecting channel design according to the invention in making the reactant gas distribution uniform.

A further reason for the excellent results obtained with this design lies probably in the increased humidification efficiency of the reactant gases, and particularly of the air, which was supplied after saturation at 1.5 bar. For a saturation efficiency close to 100%, it can be assumed that by saturating air at 70° C., the molar fraction of water vapour be about 0.2; taking into consideration the case of 1.4 bar feeding, the cells of the invention will effectively experience such pressure in the active area, working at a relative humidity of about 93%, while for the cells of traditional design, with uniformly distributed pressure drops not concentrated at the outlet, an internal working pressure of about 1.2 bar can be assumed (the relative pressure being the half of that of the cells of the invention), with a resulting relative humidity of about 80%.

The adoption of the asymmetrical design in accordance with the present invention entails a higher alertness during the assemblage step of the single elementary cells of the electrochemical generator. In fact, in case one or more gaskets are rotated around their horizontal axis, one or more elementary cells would be generated whose high pressure drop channels (13) would be placed in the upper part and not in the lower one where they are destined by design. These cells would be supplied at the same flow-rate of the remaining cells, but would experience an internal pressure in their active area largely inferior to the feed one with consequent performance decay. This risk, as commented above, is apparently absent with the symmetrical gaskets of the prior art. The problem can be nevertheless overcome by adopting appropriate measures in the assemblage step, for instance providing the sealing gaskets with centring holes symmetrical with respect to the vertical axis but asymmetrical with respect to the horizontal one. In case of gasket rotation, the shift in the centring holes does not permit anymore the insertion of the gasket in the centring pins.

These holes are identified as (21) in FIGS. 5, 6 and 7.

Besides the benefit associated with the increase of the internal pressure in the active area and the increased humidification efficiency, the concentration of the pressure drop along the collecting channels according to the present invention has the additional advantage of making the withdrawal of the water condensed in the active area more effective.

Such a result is nevertheless counterbalanced by the capillary force effects becoming increasingly important when the section of the individual collecting channels decreases: it has been noticed that, due to this situation, small amounts of liquid water may be trapped in some channels, likely those that, due to the production tolerances, result to casually have a particularly reduced section, with consequent irregular flow of the discharge gases. Idle zones are thus created within the elementary cells together with flow-rate unevenness between the individual cells, with performance decay. It has been found that this drawback can be completely overcome if the collecting channels are made hydrophobic, for instance by means of application of a hydrophobic material paint, such as a suspension of polytetrafluoroethylene or preferably of thermoplastic compounds, for example polyvinylidenfluoride or tetrafluoroethylene-hexafluoroethylene copolymer or perfluoroalcoxy derivates, which may be mechanically stabilised with a thermal treatment at low temperatures, compatible with the thermal stability of the gaskets. It has been found that with these thermal treatments, thin coatings of a few micron thickness are obtained, provided with good adherence and capable of effectively resisting to the liquid water leaching or eroding action.

The finding has been described making reference to specific cases with the only purpose of making the original principles thereof easier to comprehend. It is understood that all the modifications that one skilled in the art may identify on the basis of the present text are part of the scopes of the invention as defined by the following claims.

1. An electrochemical generator comprised of at least one elementary cell comprising porous current collectors/distributors in correspondence of the active area, a feed device for reactant gases and an extraction device for reaction products and exhausts, wherein the pressure drops localised in the extraction device are substantially higher than said pressure drops localised in the feed device.

2. The generator of claim 1, wherein the feed device comprises a feed manifold and at least one distributing channel and that the extraction device comprises a discharge manifold and at least one collecting channel.

3. The generator of claim 2 wherein said pressure drop localised in the feed device is concentrated within said at least one distributing channel and said pressure drop localised in the extraction device is concentrated within said at least one collecting channel.

4. The generator of claim 1 wherein the pressure inside the current collectors/distributors in correspondence of the active area is substantially equivalent to the pressure in the feed device.

5. Th generator of claim 4, wherein the pressure in the feed device is lower than or equal to 1.5 bar abs.

6. The generator of claim 2
wherein said at least one collecting channel has a substantially lower passage section than said at least one distributing channel.

7. The generator of claim 2 wherein said at least one collecting channel has a substantially higher length than said at least one distributing channel.

8. The generator of claim 2 comprising an amount of said collecting channels lower than the amount of said distributing channels.

9. The generator of claim 1 wherein said at least one elementary cell comprises sealing gaskets provided with centring holes symmetrical with respect to the vertical axis and asymmetrical with respect to the horizontal axis.

10. The generator of claim 2 wherein said at least one collecting channel is made hydrophobic.

11. The generator of claim 10 wherein said at least one collecting channel is made hydrophobic by applying suspensions of fluorinated polymers.

12. The generator of claim 11 wherein said fluorinated polymers are selected from the group consisting of polytetrafluoroethylene, polyvinylidenfluoride, tetrafluoroethylene-hexafluoroethylene copolymer, perfluoroalcoxy derivatives.

13. The generator of claim 2 wherein said distributing and collecting channels are obtained in the sealing gaskets.

14. The generator of claim 2 wherein said distributing and collecting channels are obtained in the interior of bipolar plates delimiting the elementary cells.

15. (canceled)
